(19) United States
(12) Patent Application Publication
(10) Pub. No.: US 2013/0170207 A1
(43) Pub. Date: Jul. 4, 2013

(54) Cut-Off LED Lens

(71) Applicant: JOSEPH GARCIA, San Antonio, TX (US)

(72) Inventor: JOSEPH GARCIA, San Antonio, TX (US)

(73) Assignee: KONINKLIJKE PHILIPS ELECTRONICS N.V., EINDHOVEN (NL)

(21) Appl. No.: 13/340,906

(22) Filed: Dec. 30, 2011

(51) Int. Cl. F21V 5/04; F21V 29/00; F21V 13/02

(52) U.S. Cl. 362/238; 362/235; 362/332

(57) ABSTRACT

Inventive methods and apparatus for a cut-off LED lens (20) that may be utilized with a LED bollard. The cut-off LED lens (20) is positionable over top of a plurality of LEDS (42a, 42b) and may include a plurality of protruding optics (24, 26) each positioned to align with one of the LEDs (42a, 42b).

### TECHNICAL FIELD

The present invention is directed generally to a cut-off LED lens. More particularly, various inventive methods and apparatus disclosed herein relate to a full cut-off LED lens that may be utilized with a LED bollard lighting fixture.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Bollard lighting fixtures that include LEDs have been introduced in order to achieve one or more of the advantages and benefits of LEDs. However, such bollard lighting fixtures may suffer from one or more drawbacks. For example, such bollard lighting fixtures may not offer full-cut-off light output. Also, for example, such bollard lighting fixtures may not provide optics that have satisfactory placement and/or characteristics.

Thus, there is a need in the art to provide a cut-off LED lens that may be utilized with a LED bollard lighting fixture and that may optionally overcome one or more drawbacks of existing designs.

### SUMMARY

The present disclosure is directed to inventive methods and apparatus for a cut-off lens. For example, various inventive methods and apparatus disclosed herein relate to a full cut-off LED lens that may be utilized with a LED bollard. The cut-off LED lens is positionable over top of a plurality of LEDS and may include a plurality of protruding optics each positioned to align with one of the LEDs

Generally, in one aspect, a full cut-off lens for an LED bollard having a plurality of annularly arranged LEDs is provided. The full cut-off lens includes a first side having a plurality of annularly arranged LED cavities and a second side having a plurality of annularly arranged protruding individual optics. Each of the LED cavities is sized to receive at least a portion of a single of the LEDs and each of the individual optics is positionally aligned with a single of the LED cavities. Each of the individual optics is configured to redirect substantially all light output generated from a single of the LEDs received within a respective of the LED cavities within a vertical range between nadir and ninety degrees from nadir.

In some embodiments the individual optics include a plurality of first type optics and a plurality of second type optics. In some versions of those embodiments the first type optics and the second type optics are interspersed on the lens.

In some embodiments the LED cavities and the individual optics are cohesively formed. In some versions of those embodiments the full cut-off lens is a cohesively formed annular lens.

In some embodiments the full cut-off lens has an annular outer diameter.

In some versions of those embodiments the full cut-off lens has an annular inner diameter.

Generally, in another aspect, a bollard LED lighting unit is provided and includes a plurality of annularly arranged LEDs mounted to a surface. Each of the LEDs selectively generates a light output directed downward and away from the surface. A lens is mounted over top of the LEDs and includes a plurality of annularly arranged individual optics. Each of the individual optics is positionally aligned over top of a single of the annularly arranged LEDs and vertically redirects substantially all of the light output therefrom within a range between nadir and ninety degrees from nadir.

In some embodiments the individual optics include a plurality of first type optics and a plurality of second type optics. In some versions of those embodiments the first type optics and the second type optics are interspersed and equally spaced on the lens.

In some embodiments the first type optics are type II optics. In some versions of those embodiments the second type optics are type IV optics.

In some embodiments a first grouping of the LEDs may each generate the light output independent of a second grouping of the LEDs. In some versions of those embodiments the first grouping includes a consecutive approximate half of the LEDs.

In some embodiments the LEDs are substantially evenly spaced from one another.

Generally, in another aspect, a LED lighting unit is provided that includes a heatsink having a recess in a downward facing portion thereof and a plurality of LEDs mounted to the recess of the heatsink. Each of the LEDs selectively generates a light output directed downward and away from the recess. A lens is mounted over top of the LEDs and includes optics aligned over top of the LEDs. The optics include a first type of optics and a second type of optics which collectively redirect substantially all of the light output from the LEDs within a vertical range between nadir and ninety degrees from nadir.

In some embodiments the LED lighting unit achieves IES full cut-off classification.

In some embodiments the LED lighting unit further includes at least one LED board supporting the LEDs. In some versions of those embodiments the LED board and the LEDs are at least partially received in a recess of the lens.

In some embodiments the optics are annularly arranged.

In some embodiments the lens is infused with a diffusing material

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an exploded perspective view of an embodiment of a bollard lighting fixture that includes an embodiment of a LED lighting unit.

FIG. 2 illustrates a lower perspective view of portions of the bollard lighting fixture of FIG. 1, including the embodiment of the LED lighting unit.

FIG. 3 illustrates a lower exploded perspective view of the embodiment of the LED lighting unit.

FIG. 4 illustrates an upper exploded perspective view of the embodiment of the LED lighting unit.

FIG. 5 illustrates a perspective view of an outward facing portion of a lens of the embodiment of the LED lighting unit.

FIG. 6 illustrates a plan view of the outward facing portion of the lens of the embodiment of the LED lighting unit.

FIG. 7 illustrates a plan view of an inward facing portion of the lens of the embodiment of the LED lighting unit.

FIG. 8 illustrates a perspective view of an inward facing portion of the lens of the embodiment of the LED lighting unit.

FIG. 9 illustrates a side view of the lens of the embodiment of the LED lighting unit.

FIG. 10 illustrates an additional side view of the lens of the embodiment of the LED lighting unit; the side view of FIG. 10 is offset approximately ninety degrees from the side view of FIG. 9.

FIG. 11 illustrates a section view of the lens taken along the section line 11-11 of FIG. 9.

### DETAILED DESCRIPTION

Bollard lighting fixtures that include LEDs have been introduced in order to achieve one or more of the advantages and benefits of LEDs. However, such bollard lighting fixtures may suffer from one or more drawbacks. For example, such bollard lighting fixtures may not offer full-cut-off light output and/or may not provide optics that have satisfactory placement and/or characteristics. Thus, there is a need in the art to provide a cut-off LED lens that may be utilized with a LED bollard lighting fixture and that may optionally overcome one or more drawbacks of existing designs.

More generally, Applicants have recognized and appreciated that it would be beneficial to provide a full cut-off LED lens that may be utilized with a LED bollard.

In view of the foregoing, various embodiments and implementations of the present invention are directed to a cut-off LED lens.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the representative embodiments. Such methods and apparatus are clearly within the scope of the claimed invention. For example, aspects of the methods and apparatus disclosed herein are described in conjunction with a particular bollard lighting fixture configuration. However, one or more aspects of the methods and apparatus described herein may optionally be implemented in other bollard lighting fixture configurations such as, for example, bollard lighting fixtures having a differing number of LEDs, differing dispersion of LEDs, non-annularly arranged LEDs, and/or LEDs that provide different light output characteristics. Implementation of the one or more aspects of a lighting unit described herein in alternatively configured lighting fixtures is contemplated without deviating from the scope or spirit of the claimed invention.

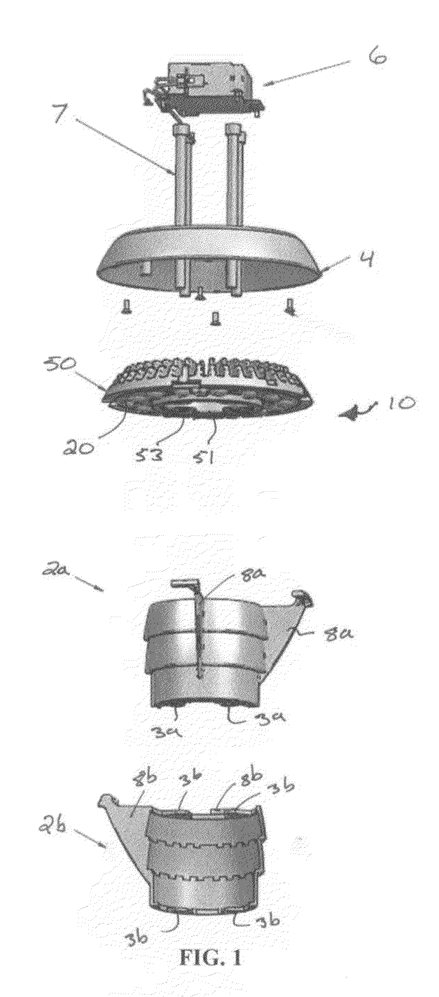

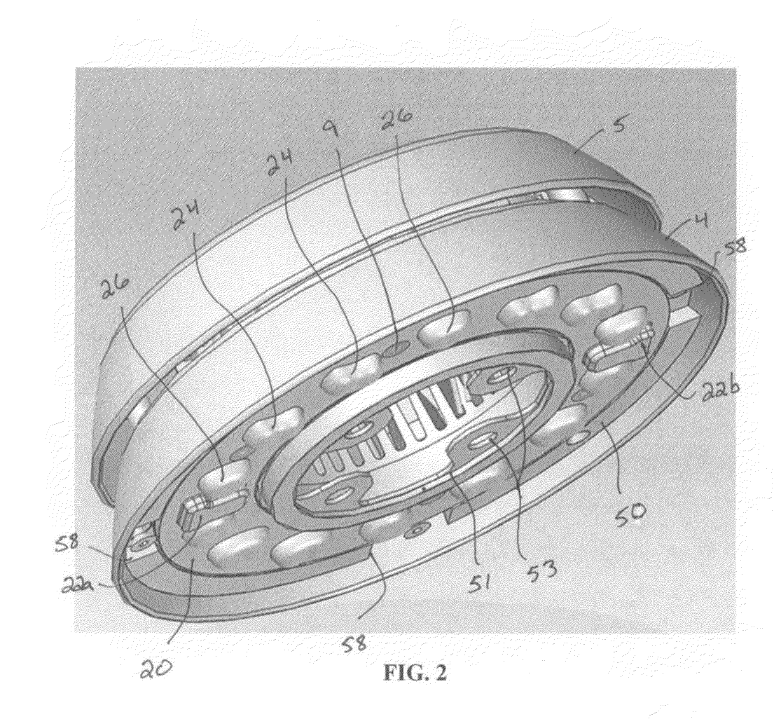

FIG. 1 illustrates an exploded perspective view of an embodiment of a bollard lighting fixture 1 that includes an embodiment of a LED lighting unit 10. The bollard lighting fixture 1 includes a lower support formed by lower support halves 2a, 2b. Lower support halves 2a, 2b include mounting bar openings 3a, 3b that receive mounting bars 7 to thereby maintain lower support halves 2a, 2b in place relative to one another and relative to other portions of the bollard lighting fixture 1. The lower support may be placed atop a bollard structure and an LED lighting unit 10 of the bollard lighting fixture 1 may be placed atop the lower support. Lower support halves 2a, 2b include planar protrusions 8a, 8b that have supports at an upper extent thereof which may be received in corresponding recesses 58 (FIGS. 2-4) of a heatsink 50 of the bollard lighting fixture to support the heatsink 50 atop the lower support.

The configuration of the lower support may minimize or prevent any downwardly directed light from LED lighting unit 10 from being reflected off lower support and redirected in a vertical direction that is at or above 90° from nadir. For example, the various surfaces of the lower support may be positioned and/or angled relative to LED lighting unit 10 and nadir such that any light output incident thereon from LED lighting unit 10 is directed in a vertical direction that is below 90° from nadir. Although a specific lower support is illustrated in FIG. 1, one of ordinary skill in the art, having had the benefit of the present disclosure, will recognize and appreciate that one or more aspects of the LED lighting unit 10 may optionally be implemented in combination with bollard lighting fixtures that have alternative lower supports or do not include lower supports.

The LED lighting unit 10 is provided atop the lower support. A lens 20 and heatsink 50 of the LED lighting unit 10 are visible in FIG. 1. The heatsink 50 includes an annular central opening 51 extending therethrough. Interior of the central opening 51 are mounting bar openings 53 that receive mounting bars 7 to thereby maintain LED lighting unit 10 in place relative other portions of the bollard lighting fixture 1. The mounting bar openings 53 may be formed as part of the heatsink 50 in some embodiments. In some other embodiments the mounting bar openings 53 may be formed in a separate annular insert that abuts an inwardly extending flange of the central opening 51.

A heatsink cover 4 may optionally be provided over the heatsink 50 and a power supply 6 optionally placed atop the heatsink 50. Electrical wiring from a power source (e.g., a mains power supply) may extend from the bollard, through the lower support, through the opening 51 and electrically couple to power supply 6. Power supply 6 may include one or more LED drivers providing electrical output to LED lighting unit 10. In some embodiments the power supply 6 may be adjustable to drive one or more groupings of LEDs of the LED lighting unit 10 at a desired level.

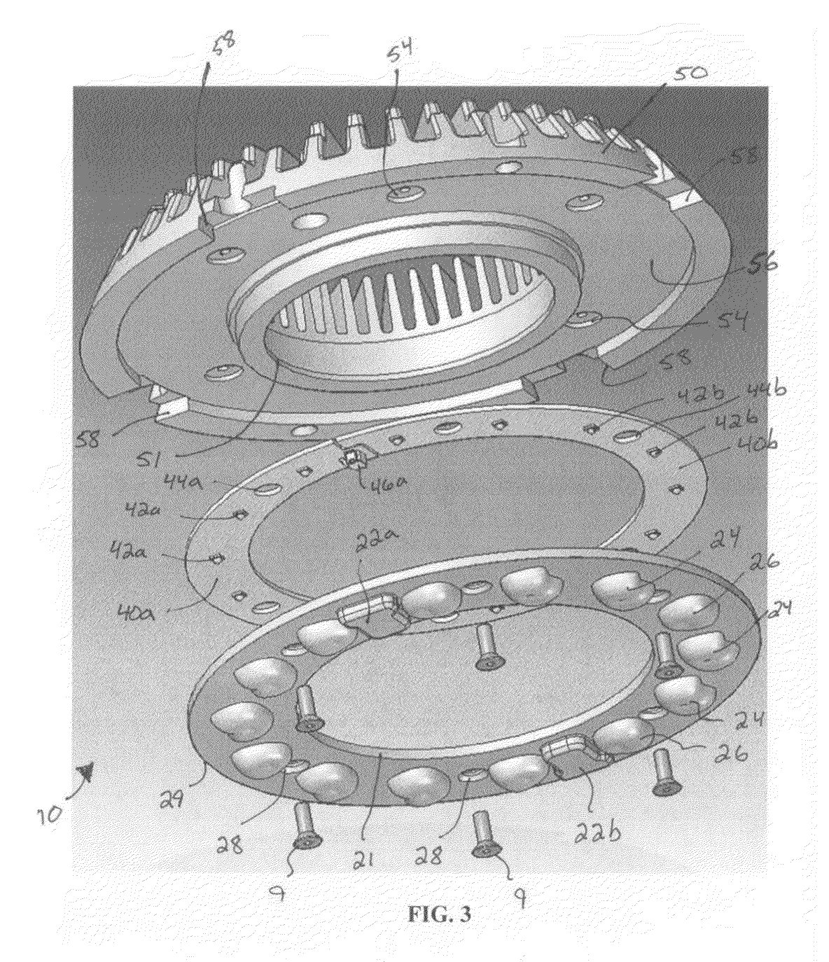

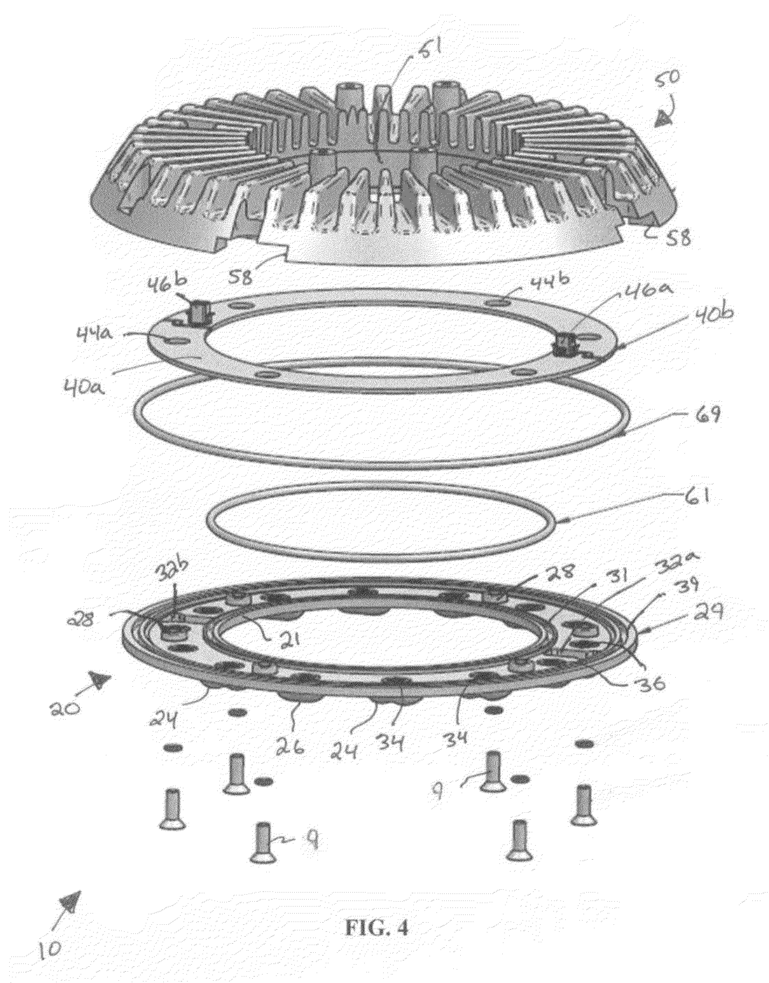

Referring now to FIGS. 2-4, the LED lighting unit 10 is illustrated and described in additional detail. FIG. 2 illustrates a lower perspective view of the LED lighting unit 10 and also illustrates the heatsink cover 4 provided over the heatsink 50 and an upper cover 5 that is provided over the heatsink cover 4 and power supply 6. FIG. 3 illustrates a lower exploded perspective view of the LED lighting unit 10 and FIG. 4 illustrates an upper exploded perspective view of the LED lighting unit 10. Although a heatsink 50 is illustrated in combination with the LED lighting unit 10 in FIG. 1 and in FIGS. 2-4, one of ordinary skill in the art, having had the benefit of the present disclosure will recognize and appreciate that in alternative embodiments the heatsink 50 may optionally be omitted and/or alternative heat dissipating structure may be included (e.g., fans and/or heat pipes).

The heatsink 50 includes an annular heatsink recess 56 (FIG. 3) between the central opening 51 and an outer extent of the heatsink 50. The heatsink recess 56 receives and supports a first arcuate LED board half 40a having a plurality of LEDs 42a and a second arcuate LED board half 40b having a plurality of LEDs 42b. A thermal interface pad, thermal interface grease, and/or other thermal material may optionally be interposed between the LED boards 40a, 40b and the heatsink recess 56. In alternative embodiments more or fewer LED boards may be provided (e.g., a single circular LED board, three separate arced board segments). Also, in some alternative embodiments one or more of the LEDs 42a and 42b may optionally be attached directly to the heatsink 50 without interposition of the LED board halves 40a and 40b. The LED boards 40a, 40b each include a respective controller 46a, 46b. The controllers 46a, 46b enable control of the light output of one or more of respective LEDs 42a, 42b. For example, in some embodiments controller 46a may provide for either extinguishing all of the LEDs 42a or illuminating all of the LEDs 42a. Also, for example, in some embodiments controller 46b may provide for either extinguishing all of the LEDs 42b or illuminating all of the LEDs 42b. Also, for example, in some embodiments controller 46a and/or controller 46b may provide for selective control over each individual LED of the respective LEDs 42a, 42b. In some embodiments controller 46a and/or controller 46b may be omitted.

The LED lens 20 is attached over top of the LED boards 40a, 40b. The LED lens 20 includes an annular central opening 21 and an annular outer periphery 29. The LED lens 20 also includes a plurality of annularly arranged protruding optics 24, 26 on an outward facing side thereof that are each positionally aligned with a single of the LEDs 42a, 42b. Each of the optics 24, 26 include a postionally aligned respective LED cavity 34, 36 on an inner side thereof. The LED cavities 34, 36 are each positioned and sized to surround at least a portion of a single of respective LEDs 42a, 42b and direct light output therefrom through a respective optic 24, 26. The LED cavities 34, 36 may optionally receive at least a portion of respective LEDs 42a, 42b therein. The LED lens 20 also includes a pair of opposed component protrusions 22a, 22b that correspond with respective component recesses 32a, 32b that receive portions of respective controllers 46a, 46b.

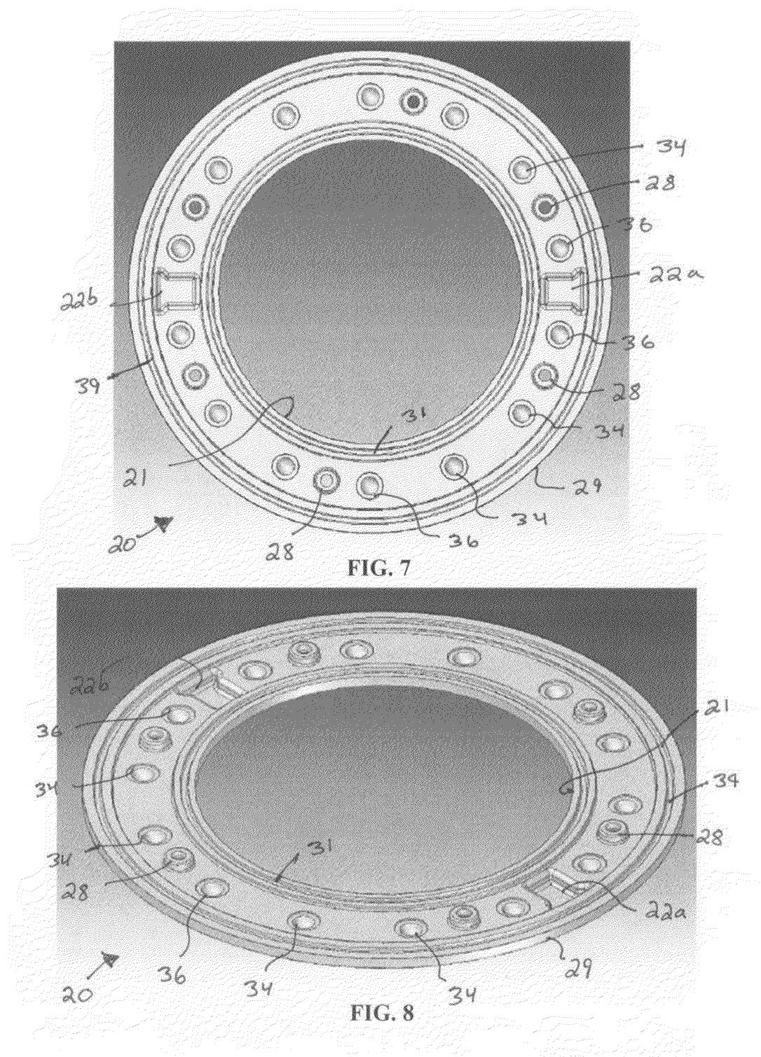

Fasteners 9 extend through fastener openings 28 (FIGS. 2 and 3) of LED lens 20, fastener openings 44a, 44b (FIGS. 2 and 3) of LED boards 40a, 40b, and into fastener receptacles 54 (FIG. 3) of heatsink 50 to compressively secure the LED lens 20 and LED boards 40a, 40b to the heatsink 50. Fastener openings 28 of LED lens 20 include a protruding collar that extends through fastener openings 44a, 44b and into fastener receptacles 54 to assist in alignment and/or to provide for sealing. O-rings (FIG. 4) may optionally be utilized in combination with the fastener 9 to improve the seal between the fasteners 9 and the LED lens 20. One of ordinary skill in the art, having had the benefit of the present disclosure, will recognize and appreciate that in alternative embodiments other coupling methods and apparatus may be utilized. As illustrated in FIG. 4, an outer gasket 69 may optionally be received in outer gasket recess 39 of LED lens 20 and an inner gasket 61 may optionally be received in inner gasket recess 31 of LED lens 20. The gaskets 61, 69 may provide ingress protection to prevent water and other elements from reaching LEDs 42a, 42b and the LED cavities 34, 36. In the illustrated embodiment the LED board halves 40a, 40b are wholly interposed between gaskets 61 and 69, thereby providing ingress protection from water and other elements. Also, in the illustrated embodiment the LED board halves 40a, 40b are at least partially received in recesses formed in the inward facing portion of the LED lens 20, between interior walls of the gasket recesses 31 and 39 (FIGS. 4, 7, 8, and 11).

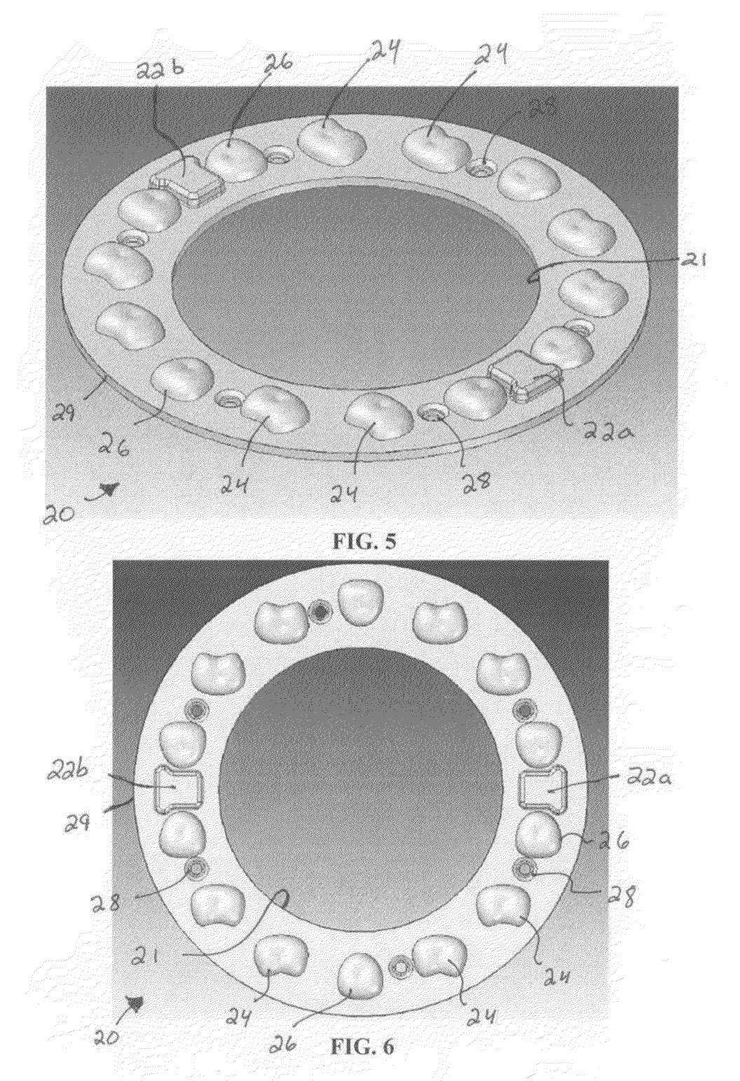

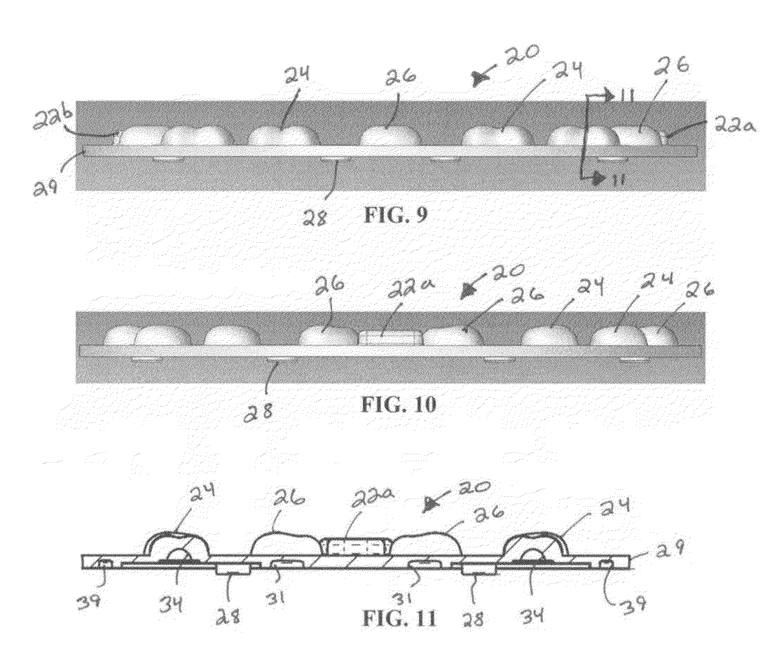

With continuing reference to FIGS. 1-4, and additional reference to FIGS. 5-11, various aspects of the LED lens 20 are described in additional detail. FIGS. 5-11 provide additional views of just the LED lens 20. LED lens 20 includes eight optics 24 that include a first substantially common configuration and six optics 26 that share a second substantially common configuration. The optics 24 and 26 are provided in an interspersed configuration with each half of the LED lens 20 (as divided by the component protrusions 22a, 22b) having, in order, a single optic 26, then two optics 24, then a single optic 26, then two optics 24, then a single optic 26. The halves of the LED lens 20 (as divided by the component protrusions 22a, 22b) are mirror images of one another. The optics 24 are free form optics having a form factor to substantially produce an Illumination Engineering Society (IES) Type II pattern. The optics 26 are free form optics having a form factor to substantially produce an Illumination Engineering Society (IES) Type IV pattern. The basic form of the optics 24 are longer in the X axis and shorter in a transverse Y axis to create more lateral projection in the light output relative to optics 26.

When all of the LEDs 42a, 42b are illuminated, the combined light output through the optics 24, 26 may produce a full cut-off IES rectangular Type V distribution pattern. The rectangular Type V distribution pattern may be beneficial for lighting walk ways by using all emitted light to only light the pathway and not the surrounding area. If only half of the LEDs (either LEDs 42a or LEDs 42b) are illuminated, the combined light output through the corresponding half of the optics may produce a full cut-off IES rectangular Type III pattern. It may be desirable to only illuminate half of the LEDs in certain lighting installations. In some versions of those implementations the bollard lighting fixture may optionally be provided with all of the LEDs 42a, 42b and a full lens and only half of the LEDs illuminated. In other versions of those implementations the bollard lighting fixture may optionally only be provided with half of the LEDs 42a, 42b and/or half of the LED lens 20.

In the illustrated embodiment the LEDs 42a, 42b and LED cavities 34, 36 are substantially evenly spaced from one another along a substantially circular path—offset approximately 26° from center to center. In alternative embodiment irregular spacing, spacing along different paths, and/or differing distances between LEDs 42a, 42b and LED cavities 34, 36 may be provided.

The specific curvature of the outer surface for each of the free form optics 24, 26 may be selected based on a number of parameters such as the light output characteristics of LEDs 42a, 42b, the spacing of LEDs 42a, 42b, height constraints, the configuration of LED cavities 34, 36, and/or required IES distributions. The surface profile of the outer surface for each of the free form optics 24, 26 and/or of the inner surface of the free form optics 24, 26 (e.g., the inner dome surface formed in the LED cavities 34, 36) may optionally be designed in a ray tracing program and modified with weighting factors and multiple iterations to create the final free form shape of the optics 24, 26. The full cut-off component of the optics 24, 26 may be derived by creating a curvature of the outer surface that cuts off emitting light at 90° vertically from nadir (directly below the LED lens 20).

Although a specific placement of specific optics are illustrated herein, one of ordinary skill in the art, having had the benefit of the present disclosure, will recognize and appreciate that alternative and/or additional optics may be designed to produce a desired light output and/or to interface with one or more particular LEDs. Moreover, differing placement of the optics illustrated herein and/or alternative optics may be utilized to achieve a desired light output and/or to interface with one or more particular LEDs. For example, in some embodiments if an LED is utilized that has substantially different light output characteristics it may be desirable to modify the optics 24 and/or 26 to continue to produce respective Type II and Type IV patterns. Also, for example, if it is desired to achieve a Type II pattern from the lighting unit 10, Type II optics such as optics 24 can be designed and populated in approximately a 180° range in combination with corresponding LEDs in approximately a 180° -range to produce an overall full cut-off IES Type II distribution pattern. Also, for example, if it is desired to achieve a Type IV pattern from the lighting unit 10, Type IV optics such as optics 26 can be designed and populated in approximately a 180° range in combination with corresponding LEDs in approximately a 180° range to produce an overall full cut-off IES Type IV distribution pattern. Also, for example, if it is desired to achieve either a Type IV pattern or a Type II pattern from the lighting unit 100, Type IV optics such as optics 26 can be designed and populated in approximately a 180° range in combination with corresponding LEDs in approximately a 180° range and Type II optics such as optics 24 can be designed in populated in the other approximately 180° range in combination with corresponding LEDs. Only the LEDs corresponding with the Type II optics may be illuminated to produce an asymmetric overall full cut-off IES Type II distribution pattern and only the LEDs corresponding with the Type IV optics may be illuminated to produce an asymmetric overall full cut-off IES Type IV distribution pattern. Also, all the LEDs may be illuminated to produce a combinational Type II and Type IV pattern.

In some embodiments the LED lens 20 may be manufactured as a single piece of acrylic. In some embodiments texturing may optionally be provided on the exterior surface of the LED lens 20. In some versions of those embodiments the exterior surface of the optics 24, 26 may optionally not be provided with texturing. In some embodiments all or portions of the LED lens 20 may optionally be infused with a diffusing material to create a diffuse LED lens. For example, in some embodiments at least the optics 24, 26 may be infused with a diffusing material to create diffuse optics. Also, for example, in some embodiments the entire LED lens 20 may be infused with a diffusing material. In some embodiments the diffusing material may include light diffusing fine particles formed of a light transparent material. Although an annular heatsink recess 56, an annular LED board having annularly arranged LEDs 42a, 42b, and an annular LED lens 20 having annularly arranged optics 24, 26 are illustrated herein, in alternative embodiments one or more components may have a non-annular configuration. For example, in some embodiments a rectangular heatsink recess, rectangular LED board having rectangularly arranged LEDs, and a rectangular LED lens 20 having rectangularly arranged optics may be provided.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A full cut-off lens for an LED bollard having a plurality of annularly arranged LEDs, comprising:
a first side having a plurality of annularly arranged LED cavities (34, 36), each of said LED cavities (34, 36) sized to receive at least a portion of a single of said LEDs;
a second side having a plurality of annularly arranged protruding individual optics (24, 26), each of said individual optics (24, 26) positionally aligned with a single of said LED cavities (34, 36);
wherein each of said individual optics (24, 26) is configured to redirect substantially all light output generated from a single of said LEDs received within a respective of said LED cavities (34, 36) within a vertical range between nadir and ninety degrees from nadir.

2. The full cut-off lens of claim 1, wherein said individual optics (24, 26) include a plurality of first type optics and a plurality of second type optics.

3. The full cut-off lens of claim 2, wherein said first type optics and said second type optics are interspersed on said lens.

4. The full cut-off lens of claim 1, wherein said LED cavities (34, 36) and said individual optics (24, 26) are cohesively formed.

5. The full cut-off lens of claim 4, wherein said full cut-off lens is a cohesively formed annular lens.

6. The full cut-off lens of claim 1, wherein said full cut-off lens has an annular outer diameter.

7. The full cut-off lens of claim 6, wherein full cut-off lens has an annular inner diameter.

8. A bollard LED lighting unit, comprising:
a plurality of annularly arranged LEDs (42a, 42b) mounted to a surface, each of said LEDs (42a, 42b) selectively generating a light output directed downward and away from said surface;
a lens mounted over top of said LEDs (42a, 42b), said lens including a plurality of annularly arranged individual optics (24, 26);
wherein each of said individual optics (24, 26) is positionally aligned over top of a single of said annularly arranged LEDs (42a, 42b) and vertically redirects substantially all of said light output therefrom within a range between nadir and ninety degrees from nadir.

9. The bollard LED lighting unit of claim 8, wherein said individual optics (24, 26) include a plurality of first type optics and a plurality of second type optics.

10. The bollard LED lighting unit of claim 9, wherein said first type optics and said second type optics are interspersed and equally spaced on said lens.

11. The bollard LED lighting unit of claim 10, wherein said first type optics are type II optics.

12. The bollard LED lighting unit of claim 11, wherein said second type optics are type IV optics.

13. The bollard LED lighting unit of claim 8, wherein a first grouping of said LEDs (42a, 42b) may each generate said light output independent of a second grouping of said LEDs (42a, 42b).

14. The bollard LED lighting unit of claim 13, wherein said first grouping includes a consecutive approximate half of said LEDs (42a, 42b).

15. The bollard LED lighting unit of claim 8, wherein said LEDs (42a, 42b) are substantially evenly spaced from one another.

16. A LED lighting unit, comprising:
a heatsink (50) having a recess (56) in a downward facing portion thereof;
a plurality of LEDs (42a, 42b) mounted to said recess (56) of said heatsink (50), each of said LEDs (42a, 42b) selectively generating a light output directed downward and away from said recess (56);
a lens (20) mounted over top of said LEDs (42a, 42b), said lens (20) including optics (24, 26) aligned over top of said LEDs;
wherein said optics (24, 26) include a first type of optics and a second type of optics which collectively redirect substantially all of said light output from said LEDs (42a, 42b) within a vertical range between nadir and ninety degrees from nadir.

17. The LED lighting unit of claim 16, wherein said LED lighting unit achieves IES full cut-off classification.

18. The LED lighting unit of claim 16, further comprising at least one LED board (40a, 40b) supporting said LEDs.

19. The LED lighting unit of claim 18, wherein said LED board (40a, 40b) and said LEDs (42a, 42b) are at least partially received in a recess of said lens.

20. The LED lighting unit of claim 16, wherein said optics (24, 26) are annularly arranged.

21. The LED lighting unit of claim 16, wherein said lens is infused with a diffusing material.
